(19) United States
(12) Patent Application Publication
(10) Pub. No.: US 2024/0257086 A1
(43) Pub. Date: Aug. 1, 2024

(54) SYSTEMS AND METHODS FOR COLLECTIBLES

(71) Applicant: The Upper Deck Company, Carlsbad, CA (US)

(72) Inventors: Benjamin Swiderski, San Marcos, CA (US); Jason Masherah, Carlsbad, CA (US)

(21) Appl. No.: 18/104,564

(22) Filed: Feb. 1, 2023

(51) Int. Cl. G06Q 20/12; G06Q 20/10; G06Q 20/38

(52) U.S. Cl. CPC G06Q 20/1235; G06Q 20/10; G06Q 20/389

(57) ABSTRACT

A system can be configured to facilitate collecting and actions associated with collectibles, including collecting and actions involving various types of collectibles. A system can be configured to perform operations including generating a physical collectible record associated with a physical collectible and a physical collectible system; generating a digital-only collectible record associated with a digital-only collectible and an electronic collectible system; generating an NFT collectible record associated with an NFT collectible and an NFT collectible system; and/or transferring the physical collectible and the NFT collectible to the electronic collectible system. The physical collectible system and the NFT collectible system can be in electronic communication with the electronic collectible system.

### FIELD

The present disclosure generally relates to systems and methods for collectibles.

### BACKGROUND

The interest and hobby of collecting various items continues to grow and evolve. Physical collectibles continue to be of interest, and now with digital collectibles and assets growing in popularity, collectors desire ways to acquire, store, display, utilize, and/or transact with such digital collectibles and assets. However, with both physical and digital collectibles available and included in collections, there can be difficulty in cataloging and keeping track of all of one's collectibles in a convenient or useful manner, and it can be difficult to involve physical and digital collectibles within the same systems, transactions, displays, and/or the like.

### SUMMARY

Systems and methods for collectibles are disclosed herein. In various examples, the systems and methods can be configured to allow a user to store, ship, transact with (e.g., buy, sell, and/or trade), utilize, examine, and/or display physical and digital collectibles (including digital collectibles kept on a private ledger or public ledger (e.g., a blockchain), and/or transfer physical and digital collectibles between collectible systems. A private ledger can be a ledger associated with and/or keeping track of transactions and/or transfers of collectibles between electronic collectible system 110, physical collectible system 120, and/or NFT collectible system 130, and/or between components of system 100. A public ledger can be a ledger without any direct association with system 100 and/or the components therein (e.g., without direct association with electronic collectible system 110, physical collectible system 120, and/or NFT collectible system 130). A public ledger can be viewable by the public (e.g., a blockchain).

A system, method, and article of manufacture (collectively, “the system”) are disclosed relating to collectibles. Physical, digital, and/or NFT collectibles can be provided. Physical collectibles can be stored in a physical location. In various examples, the system can be configured to perform operations including generating, by a processor, a physical collectible location record associated with the physical location of a physical collectible and a physical collectible system; generating, by the processor, a physical collectible record associated with the physical collectible and the physical collectible system; associating, by a processor, the physical collectible with a physical collectible user profile in the physical collectible system; presenting, by the processor and on a physical collectible system graphical user interface (GUI), an input device for at least one of an electronic transfer of the physical collectible or a physical transfer of the physical collectible; receiving, by the processor, a selection of the input device for an electronic transfer of the physical collectible; and electronically transferring, by the processor, the physical collectible to an electronic collectible system in electronic communication with the physical collectible system. Transferring the physical collectible to the electronic collectible system can comprise transferring, by the processor, the physical collectible record to the electronic collectible system and/or generating, by the processor, a digital collectible record based on the physical collectible record. The physical location of the physical collectible can remain the same in response to electronically transferring the physical collectible to the electronic collectible system. In various examples, associating the physical collectible with the physical collectible user profile can be in response to receiving, by the processor, a payment for the physical collectible.

In various examples, the input device can be for the physical transfer of the physical collectible, and electronically transferring the physical collectible to the electronic collectible system can occur automatically in response to associating the physical collectible to the physical collectible user profile in the physical collectible system.

In various examples, the physical collectible record can comprise a physical collectible image and a physical collectible description of the physical collectible. The operations can further comprise displaying, by the processor, the physical collectible image and the physical collectible description on an electronic collectible system GUI in response to the transferring the physical collectible to the electronic collectible system. In various examples, the operations can further comprise (automatically) deleting, by the processor, the physical collectible record from the physical collectible system in response to the electronically transferring the physical collectible to the electronic collectible system. In various examples, the digital collectible record can comprise ownership information associated with an ownership of the physical collectible. The operations can further comprise associating, by the processor, the physical collectible with a digital collectible user profile in the electronic collectible system in response to electronically transferring the physical collectible to the electronic collectible system; receiving, by the processor, a command to change the ownership of the physical collectible to a second digital collectible user profile in the electronic collectible system; and/or revising, by the processor, the ownership information for the physical collectible to be associated with the second digital collectible user profile in response to receiving the command to change the ownership. The physical location of the physical collectible can remain the same in response to the revising the ownership of the physical collectible.

In various examples, the operations can further comprise presenting, by the processor and on the electronic collectible system GUI, a second input device indicating available actions for a collectible, including physical transfer of the physical collectible; receiving, by the processor, a selection of the second input device for the physical transfer of the physical collectible; and/or commanding, by the processor, shipping the physical collectible to a second physical location. The physical collectible can be shipped to the second physical location in response to such a command. In various examples, the operations can further comprise automatically deleting, by the processor, the digital collectible record for the physical item in response to shipping the physical collectible.

In various examples, the operations can further comprise providing, by the processor, a digital-only digital collectible not associated with any physical collectible in the electronic collectible system; generating, by the processor, a digital-only collectible record in the electronic collectible system associated with the digital-only digital collectible, wherein the digital-only collectible record is logged in a private ledger associated with the electronic collectible system; and/or associating, by a processor, the digital-only digital collectible with a digital collectible user profile in the electronic collectible system. In various examples, the digital-only collectible record can comprise ownership information associated with an ownership of the digital-only digital collectible. The operations can further comprise receiving, by the processor, a command to change the ownership of the digital-only digital collectible to a second digital collectible user profile in the electronic collectible system; and/or revising, by the processor, the ownership information of the digital-only digital collectible to be associated with the second digital collectible user profile in response to receiving the command to change the ownership.

In various examples, the operations can further comprise presenting, by the processor, a redeem input device on the electronic collectible system GUI through which a user is able to redeem a redeemed collectible in exchange for at least one of the digital-only digital collectible or the physical collectible; receiving, by the processor, a selection of the redeem input device; automatically generating, by the processor, a redeemed collectible record associated with the redeemed collectible; associating, by the processor, the redeemed collectible record with the digital collectible user profile; and/or automatically deleting, by the processor, at least one of the digital-only collectible record or the digital collectible record associated with the physical collectible from the digital collectible user profile.

In various examples, the operations can further comprise providing, by the processor, an NFT collectible in an NFT collectible system in electronic communication with the electronic collectible system, wherein the NFT collectible is stored on a blockchain; generating, by the processor, an NFT collectible record in the NFT collectible system associated with the NFT collectible, wherein the NFT collectible record is logged in a private ledger associated with the NFT collectible system; and/or associating, by a processor, the NFT collectible with an NFT collectible user profile in the NFT collectible system. In various examples, the operations can further comprise presenting, by the processor and on an NFT collectible system GUI, an input device for an electronic transfer of the NFT collectible; receiving, by the processor, a selection of the input device; and/or transferring, by the processor, the NFT collectible record to the electronic collectible system.

### BRIEF DESCRIPTION OF THE DRAWINGS

The subject matter of the present disclosure is particularly pointed out and distinctly claimed in the concluding portion of the specification. A more complete understanding of the present disclosure, however, may best be obtained by referring to the detailed description and claims when considered in connection with the drawing figures. In the figures, like referenced numerals can refer to like parts throughout the different figures unless otherwise specified.

FIG. 1 illustrates an exemplary system for collectibles, in accordance with various examples.

FIG. 2 illustrates an exemplary display screen on a user device depicting a GUI provided by an electronic collectible system, in accordance with various examples.

FIG. 3 illustrates an exemplary display screen on a user device depicting a GUI provided by a physical collectible system, in accordance with various examples.

FIG. 4 illustrates an exemplary display screen on a user device depicting a GUI provided by an NFT collectible system, in accordance with various examples.

FIG. 5 illustrates a flowchart depicting an exemplary method for operating a system for collectibles including physical collectibles, in accordance with various examples.

FIG. 6 illustrates a flowchart depicting an exemplary method for operating a system for collectibles including digital collectibles, in accordance with various examples.

FIG. 7 illustrates a flowchart depicting an exemplary method for operating a system for collectibles including NFT collectibles, in accordance with various examples.

### DETAILED DESCRIPTION

The detailed description of various examples herein makes reference to the accompanying drawings, which show the examples by way of illustration. While these examples are described in sufficient detail to enable those skilled in the art to practice the disclosure, it should be understood that other examples can be realized and that logical, electrical, digital, and/or mechanical changes can be made without departing from the spirit and scope of the disclosure. Thus, the detailed description herein is presented for purposes of illustration only and not of limitation. For example, the steps recited in any of the method or process descriptions can be executed in any order or combination and are not limited to the order or combination presented, and the steps described in one method can be implemented in another method discussed herein. Moreover, any of the functions or steps can comprise intervening steps therebetween and/or can be outsourced to or performed by one or more third parties. Furthermore, any of the functions or steps can be outsourced to or performed by one or more third parties. Furthermore, any reference to singular includes plural examples, and any reference to more than one component can include a singular example.

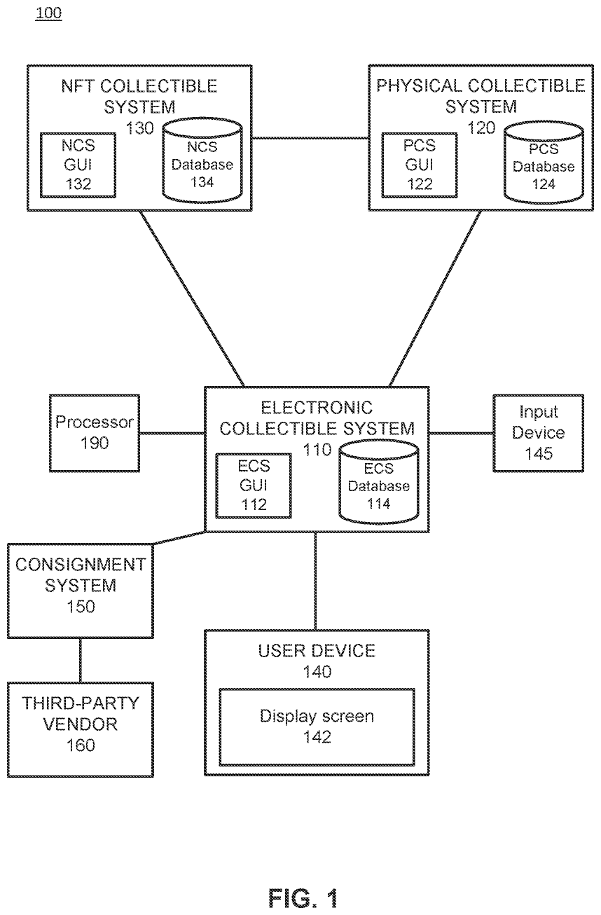

With reference to FIG. 1, an exemplary system 100 for collectibles is illustrated, in accordance with various examples. System 100 can allow a user to easily and efficiently store, keep track of, display, examine, transact with, transfer, and/or utilize various collectibles. The collectibles within system 100 can be fixed to any suitable medium. For example, the collectibles can be physical and/or digital. As used herein, a “collectible” can be a tangible item, a digital item, and/or a hybrid collectible having both a tangible (i.e., physical) component and a digital component. A “collectible” thus includes physical collectibles (e.g., trading cards, memorabilia, artwork, physical images or photographs, game-used or event-used items (e.g., sports or entertainment equipment), professional sports collectibles, other non-professional sports collectibles, entertainment collectibles, venue surfaces, and/or the like), electronic or digital collectibles (e.g., digital images including photographs, artwork, text, and/or the like (e.g., digital trading cards), digital artwork, video clips, songs, sound clips, and/or the like), non-fungible token (NFT) collectibles (e.g., a digital collectible with a record, and/or being stored, on a public ledger such as a blockchain), and/or a hybrid collectible (e.g., a collectible having a digital component, NFT component, and/or physical component). A digital item or a digital component of a hybrid collectible may be a digital file stored in a non-transitory memory, in a fixed medium, that is representative of the collectible, whether in audio, visual, or other format, whether secured with cryptography or not.

In various examples, system 100 can comprise an electronic collectible system 110, a physical collectible system 120, an NFT collectible system 130, a user device 140, an input device 145, a consignment system 150, a third-party vendor system 160, and/or a processor 190. In various examples, any or all of the components of system 100 can be integrated, and/or in electronic communication, with one another via one or more application programming interfaces (APIs). System 100 and/or any of the components comprised therein can be computer-based, and can comprise a processor (e.g., processor 190), a tangible non-transitory computer-readable memory, and/or a network interface. Instructions stored on the tangible non-transitory memory can allow system 100 or processor 190, or the components therein, to perform various functions, as described herein. In various examples, one or more processors (e.g., processor 190) can control, preform, and/or facilitate the functions of all components of system 100.

In various examples, electronic collectible system 110 can comprise hardware and/or software capable of storing data and/or analyzing information. Electronic collectible system 110 can comprise a server appliance running a suitable server operating system (e.g., MICROSOFT INTERNET INFORMATION SERVICES or, “IIS”) and having database software (e.g., ORACLE) installed thereon. Electronic collectible system 110 can be in electronic communication with physical collectible system 120, NFT collectible system 130, user device 140, consignment system 150, a third-party vendor system 160, and/or processor 190 via a network. As such, electronic collectible system 110 can be able to communicate, and/or share information, with physical collectible system 120, NFT collectible system 130, user device 140, consignment system 150, a third-party vendor system 160, and/or processor 190.

In various examples, electronic collectible system 110 can comprise an ECS GUI 112, which can display information to a user on the display screen of a user device and provide the user with input devices 145 to allow the user to interact and communicate with electronic collectible system 110, and an ECS database 114. ECS database 114 can store data and information associated with collectibles (e.g., digital collectibles, physical collectibles, NFT collectibles, collectible records associated therewith, and/or the like). Any of the components of electronic collectible system 110 can be in electronic communication with one another. Electronic collectible system 110 can comprise a processor therein and/or utilize a processor in another component of system 100 (e.g., processor 190). The processor can be configured to receive inputs from the user through input device 145, perform the functions, or instruct/facilitate the performance of functions, of electronic collectible system 110 and/or system 100 including, for example, communicating with other systems (e.g., within and outside of system 100), receiving a collectible record (e.g., information regarding a collectible) from another component of system 100, generating a collectible record associated with a collectible, displaying information about a collectible (e.g., photographs, images, descriptions, etc.), revising a collectible record for a collectible, facilitating transactions involving collectibles (e.g., buying, selling, trading, and/or redeeming collectibles, and/or the like), utilizing or interacting with collectibles, displaying collectibles, organizing collectibles, storing collectibles, revealing collectibles (e.g., opening digital packs of digital trading cards), organizing collectibles, and/or the like.

Input device(s) 145 can be an aspect of a GUI displayed on display screen which, in response to being selected, allows a user of system 100 to produce an input signal received by a processor, which can command the processor to perform or facilitate performance of an operation. For example, input device 145 can be a digital button displayed on a display screen (e.g., a touch screen) which can be selected by tapping the screen on a touch screen or selecting input device 145 with a computer mouse, and/or input device 145 can be a physical button to input information.

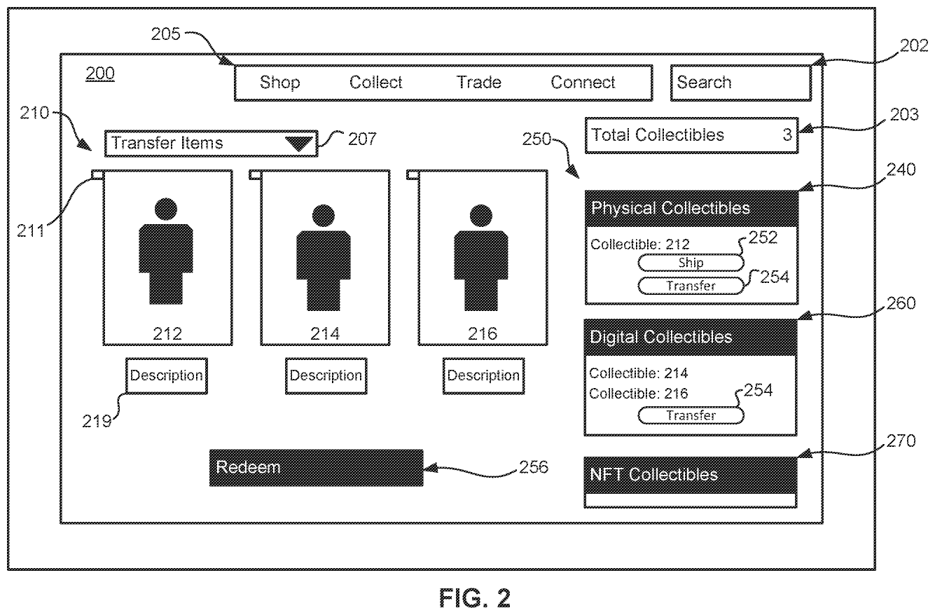

With additional reference to FIG. 2, an ECS GUI 200 (an example of ECS GUI 112 in FIG. 1) is depicted in accordance with various examples. An ECS GUI can allow a user to interact and communicate with electronic collectible system 110. ECS GUI 200, for example, can have an action selection pane 205 from which a user can select a desired action. For example, if the user is interested in purchasing a collectible (e.g., a digital, digital-only, physical, and/or NFT collectible), the user can select “shop.” As another example, if the user is interested in taking actions associated with collecting, the user can select “collect.” As another example, if the user is interested in taking actions associated with trading collectibles, the user can select “trade.” As yet another example, if the user is interested in taking actions associated with connecting or interacting with other users, the user can select “connect.”

A user can search for various items (e.g., relating to a certain sports team, theme, brand, having desired characteristics, and/or the like) within electronic collectible system 110 (e.g., different collectibles or features of electronic collectible system 110) by utilizing a search bar 202. A user can select various collectibles (e.g., from their own collection or the collection or inventory of another party), upon or with which the user can act and/or transact. For example, the user of GUI 200 may have searched for various collectibles and selected collectibles 212, 214, and 216. Collectibles 212-216 can be displayed in collectible display area 210. Collectibles 212-216 may be part of the user's own collection, or collectibles 212-216 can be part of another user's collection or offered for sale, for example, that the user would like to acquire by sale, trade, or otherwise.

Electronic collectible system 110 can display one or more images and/or a description 219 (e.g., information) associated with a collectible. In various examples, the display of a collectible in collectible display area 210 can comprise an identifier or marker 211 configured to indicate a characteristic of the collectible. For example, a marker 211 can indicate the type of collectible (e.g., a digital-only, physical, digital, and/or NFT collectible), whether an action can be taken on the selected collectible (e.g., whether a collectible can be transferred to another user profile, physically shipped to a desired address, redeemed for another collectible (e.g., a redeemed collectible), bought or sold, and/or the like), a collectible category (e.g., a collectible relating to sports, games, fantasy worlds or universes, etc.). In various examples, the description 219 associated with a collectible can convey information to the viewer about the respective collectible, such as the associated title, brand, pictured subject, rarity, ownership information, collectible type, availability for certain actions, and/or the like.

In various examples, ECS GUI 200 can allow a user to select an action to take with regard to selected collectibles. For example, an action menu (e.g., action menu 207) can allow the user to transfer, ship, trade, redeem, buy, sell, and/or organize collectibles, and/or take any other suitable action. In action menu 207, the user has selected to transfer items. Electronic collectible system 110 can indicate to the user how many collectibles, and how many collectibles having a certain characteristic, are selected or present in a collection. For example, the user of ECS GUI 200 has selected collectibles 212-216. Electronic collectible system 110 can count the number of collectibles selected and present the total in Total Collectibles box 203. In this case, the user has selected three collectibles. In various examples, electronic collectible system 110 can indicate how many of each collectible comprise a certain characteristic. For example, ECS GUI 200 indicates that collectible 212 is a physical collectible (or the digital collectible and/or physical collectible record displayed as collectible 212 is associated a physical collectible). The physical collectibles are presented in physical collectible box 240. ECS GUI 200 further indicates that collectibles 214 and 216 are digital collectibles (e.g., digital-only collectibles with no associated physical collectible), which are presented in digital collectibles box 260. ECS GUI 200 can also indicate if there are any NFT collectibles by presenting information related thereto in NFT collectibles box 270. Thus, as discussed herein, electronic collectible system 110 and/or system 100 allows a user to store different collectible types in a single location (e.g., the user's user account on electronic collectible system 110), and interact with and/or utilize such collectibles.

In various examples, electronic collectible system 110 can allow the user to take various actions involving collectibles, as discussed herein. For example, in response to the user indicating the desire to transfer items (e.g., in action menu 207), ECS GUI 200 can offer physical transfer (i.e., shipping) and/or electronic transfer (e.g., transferring the digital collectible and/or the collectible record associated with the collectible to another user profile or system). Ship button 252 (an example of an input device 145) can allow a user to indicate to electronic collectible system 110 to ship an associated physical collectible to a desired address. In response, system 100 and/or electronic collectible system 110 can facilitate physically delivering a physical collectible to a user or other desired address. As another example, transfer button 254 (another example of an input device 145) can allow a user to indicate to electronic collectible system 110 to transfer a collectible to another user profile within system 100 and/or electronic collectible system 110. For example, a user can transfer a physical collectible and the associated physical collectible record (a physical collectible record is the information associated with the physical collectible, which can be considered a digital collectible associated with the physical collectible), a digital-only collectible, and/or an NFT collectible to another user profile within system 100 and/or electronic collectible system 110 (e.g., in a trade or sale of a collectible).

In various examples, digital collectibles can be comprised in groups or packs (e.g., a digital pack of cards). In various examples, a digital pack of cards can be associated with a physical pack of cards, the physical pack and each physical card being a physical collectible. In various examples, a digital pack of cards can be a digital-only collectible, with each digital card therein being a digital-only collectible. The user can elect to reveal one or more of the digital cards in a digital pack (e.g., by opening the digital pack). For example, in response to the user's selection of an “open/separate” button (e.g., as shown in action menu 460 on NCS GUI 400), electronic collectible system 110 can reveal individual collectibles from a plurality (e.g., pack) of collectibles. Multiple digital packs can be opened, and/or multiple digital cards/collectibles, can be opened/revealed at once.

In various examples, system 100 and/or electronic collectible system 110 can allow a user to redeem a redeemed collectible (e.g., a prize or the like) in exchange for one or more collectibles from the user's collection). For example, in response to the user selecting a redeem action (e.g., from selecting “redeem” in action menu 207 and/or selecting redeem button 256), electronic collectible system 110 can facilitate redemption of a redeemed collectible. The redeemed collectible can be the collectible that is received in response to submitting the required collectibles. For example, electronic collectible system 110 can require that a certain number of the same collectible is required to receive a certain redeemed collectible. Thus, in response to collectibles 212-216 all being the same collectible, the user can select a redeem action, submit collectibles 212-216, and receive a redeemed collectible in exchange. In response to such a redemption, electronic collectible system 110 may (automatically) delete the collectible records for the submitted collectibles 212-216 (at least from the respective user profile), such that collectibles 212-216 are no longer associated with the respective user profile.

In various examples, physical collectible system 120 can comprise hardware and/or software capable of storing data and/or analyzing information. Physical collectible system 120 can comprise a server appliance running a suitable server operating system (e.g., MICROSOFT INTERNET INFORMATION SERVICES or, “IIS”) and having database software (e.g., ORACLE, mySQL) installed thereon. Physical collectible system 120 can be in electronic communication with electronic collectible system 110, NFT collectible system 130, user device 140, consignment system 150, a third-party vendor system 160, and/or processor 190 via a network. As such, physical collectible system 120 can be able to communicate, and/or share information, with electronic collectible system 110, NFT collectible system 130, user device 140, consignment system 150, a third-party vendor system 160, and/or processor 190.

In various examples, physical collectible system 120 can comprise a PCS GUI 122, which can display information to a user on the display screen of a user device and provide the user with input devices 145 to allow the user to interact and communicate with physical collectible system 120, and an PCS database 124. PCS database can store data and information associated with collectibles (e.g., digital collectibles, physical collectibles, NFT collectibles, and/or the like). Any of the components of physical collectible system 120 can be in electronic communication with one another. Physical collectible system 120 can comprise a processor therein and/or utilize a processor in another component of system 100 (e.g., processor 190). The processor can be configured to receive inputs from the user through input device 145, perform the functions, or instruct/facilitate the performance of functions, of physical collectible system 120 and/or system 100 including, for example, communicating with other systems (e.g., within and outside of system 100), receiving a collectible record (e.g., information regarding a collectible) from another component of system 100, generating a collectible record associated with a collectible, displaying information about a collectible (e.g., photographs, images, descriptions, etc.), revising a collectible record for a collectible, facilitating transactions involving collectibles (e.g., buying, selling, trading, and/or redeeming collectibles, and/or the like), utilizing or interacting with collectibles, displaying collectibles, organizing collectibles, storing collectibles, revealing collectibles, organizing collectibles, and/or the like.

In various examples, physical collectible system 120 can be configured to provide a collectible system for physical collectibles. For example, physical collectible system 120 can offer a marketplace for physical collectibles, in which a user can purchase physical collectibles. A physical collectible can be provided to physical collectible system 120. Physical collectible system 120 can generate a physical collectible record associated with the respective physical collectible, which can comprise images of and/or information about the physical collectible. In various examples, the physical collectible record can be considered a digital collectible counterpart to the associated physical collectible. The physical collectible record can be associated with a single, unique physical collectible (e.g., not associated with all physical collectibles of a certain type, model, issue, or the like). Therefore, the images and/or information in the physical collectible record for a physical collectible can reflect unique aspects (e.g., imperfections, damage, or overall condition) of the physical collectible. In response to a user purchasing a physical collectible, the physical collectible and associated physical collectible record can be associated with the user profile through which the purchase of the physical collectible was completed. Physical collectible records and/or user profile information for physical collectible system 120 can be stored in PCS database 124.

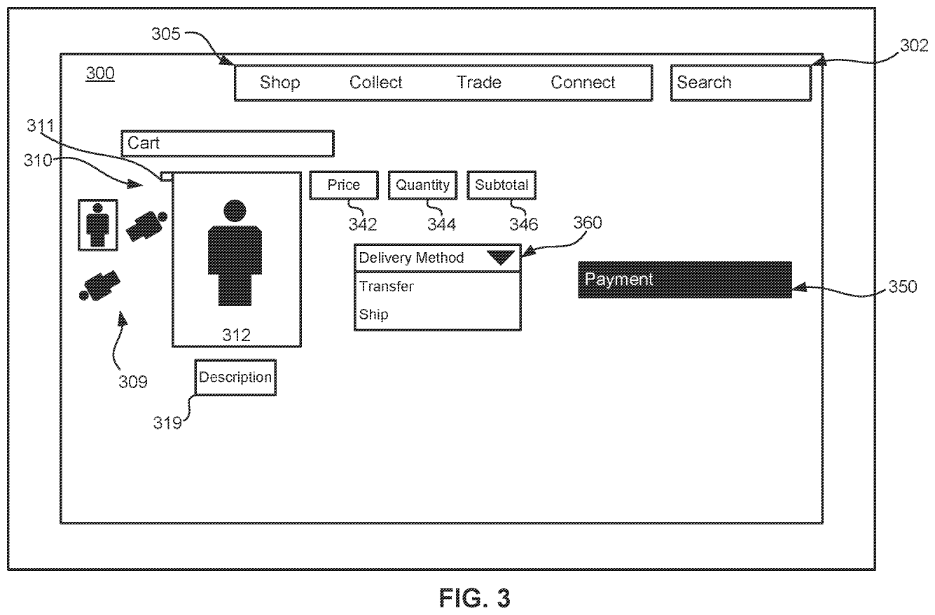

With additional reference to FIG. 3, a PCS GUI 300 (an example of PCS GUI 122 in FIG. 1) is depicted in accordance with various examples. A PCS GUI can allow a user to interact and communicate with physical collectible system 120. PCS GUI 300, for example, can have an action selection pane 305 from which a user can select a desired action (similar to action selection pane 205 in ECS GUI 200).

A user can search for various items or aspects within physical collectible system 120 (e.g., different collectibles or features of physical collectible system 120) by utilizing a search bar 302. A user can select various collectibles (e.g., from their own collection or the collection or inventory of another party), upon or with which the user can act and/or transact. For example, the user of GUI 300 may have searched for various collectibles and selected collectible 312 (which can be a physical collectible). Collectible 312, or the physical collectible record associated therewith, can be displayed in collectible display area 310. For example, physical collectible system 120 can display one or more images or views 309 and/or a description 319 (e.g., information) associated with collectible 312. The images for a physical collectible can be used to convey unique aspects, condition, damage, etc. of the specific physical collectible, as discussed herein. In various examples, the display of a collectible in collectible display area 310 can comprise an identifier or marker 311 configured to indicate a characteristic of the collectible. For example, marker 311 can indicate the type of collectible, whether an action can be taken on the selected collectible (e.g., whether a collectible can be transferred to another user profile, physically shipped to a desired address, redeemed for another collectible (e.g., a redeemed collectible), bought or sold, and/or the like), a collectible category (e.g., a collectible relating to sports, games, fantasy worlds or universes, etc.), and/or the like. In various examples, the description 319 associated with a collectible can convey information to the viewer about the respective collectible, such as the associated title, brand, pictured subject, rarity, ownership information, collectible type, availability for certain actions, condition, and/or the like.

PCS GUI 300 can be the display used to purchase a physical collectible 312 (e.g., showing what is in a user's cart to purchase). The price 342, quantity 344, and subtotal 346 for a purchase can be displayed. In various examples, PCS GUI 300 can allow a user to select an action to take with regard to selected collectibles. For example, an action menu can allow the user to transfer, ship, trade, redeem, buy, sell, and/or organize collectibles, and/or take any other suitable action. In action menu 360, the user can select to transfer or ship the items. That is, physical collectible 312 can be shipped to the user or another desired physical address or transferred to a user profile in response to being purchased. To pay for the selected physical collectible, the user can select a payment button 350 to proceed to select a payment method, enter payment information, etc.

In various examples, a physical collectible owned by a user of physical collectible system 120 can be stored in a physical location. Physical collectible system 120 can generate a physical location record associated with the location of the physical collectible. The physical location record can indicate the exact location within a physical place (e.g., a warehouse, on a shelf, and/or the like) at which the respective physical collectible is stored. The physical location record can be comprised in the physical collectible record associated with the physical collectible.

In various examples, a physical collectible having a physical collectible record in physical collectible system 120 can be transferred to electronic collectible system 110. The physical collectible record can be kept or logged on a private ledger. A user may wish to consolidate collectibles from multiple locations into a single user profile and/or collection. Such consolidation can increase the convenience for display, viewing, organizing, transacting, and utilization of collectibles of various types (e.g., digital/electronic, digital-only, physical, and/or NFT collectibles). Accordingly, physical collectibles in physical collectible system 120 can be transferred to electronic collectible system 110. Such a transfer can comprise transferring the physical collectible record from physical collectible system 120 to electronic collectible system 110 and/or electronic collectible system 110 generating a digital collectible record based on the physical collectible record. The digital collectible record can comprise the same or similar information about the physical collectible, which will be displayed on ECS GUI 112 in electronic collectible system 110 (e.g., one of collectibles 212-216 in ECS GUI 200 could be physical collectible 312 in PCS GUI 300). Thus, a user's physical collectibles can join any other collectibles already present in the user profile in electronic collectible system 110. In various examples, in response to transferring a physical collectible from physical collectible system 120 to electronic collectible system 110, the physical location of the physical collectible can remain the same. That is, the physical collectible may not be moved from its physical location, and the digital collectible record associated with the physical collectible can have the same physical location information (i.e., physical location record) as the physical collectible record. In response to transferring a physical collectible from physical collectible system 120 to electronic collectible system 110, the physical collectible can be added to a private ledger associated with electronic collectible system 110 for tracking.

In various examples, NFT collectible system 130 can comprise hardware and/or software capable of storing data and/or analyzing information. NFT collectible system 130 can comprise a server appliance running a suitable server operating system (e.g., MICROSOFT INTERNET INFORMATION SERVICES or, “IIS”) and having database software (e.g., ORACLE) installed thereon. NFT collectible system 130 can be in electronic communication with electronic collectible system 110, physical collectible system 120, user device 140, consignment system 150, a third-party vendor system 160, and/or processor 190 via a network. As such, NFT collectible system 130 can be able to communicate, and/or share information, with electronic collectible system 110, physical collectible system 120, user device 140, consignment system 150, a third-party vendor system 160, and/or processor 190.

In various examples, NFT collectible system 130 can comprise an NCS GUI 132, which can display information to a user on the display screen of a user device and provide the user with input devices 145 to allow the user to interact and communicate with NFT collectible system 130, and an NCS database 134. NCS database 134 can store data and information associated with collectibles (e.g., NFT collectibles, and NFT collectible records associated therewith). Any of the components of NFT collectible system 130 can be in electronic communication with one another.

NFT collectible system 130 can comprise a processor therein and/or utilize a processor in another component of system 100 (e.g., processor 190). The processor can be configured to receive inputs from the user through input device 145, perform the functions, or instruct/facilitate the performance of functions, of NFT collectible system 130 and/or system 100 including, for example, communicating with other systems (e.g., within and outside of system 100), receiving a collectible record (e.g., information regarding a collectible) from another component of system 100, generating a collectible record associated with a collectible, displaying information about a collectible (e.g., photographs, images, descriptions, etc.), revising a collectible record for a collectible, facilitating transactions involving collectibles (e.g., buying, selling, trading, and/or redeeming collectibles, and/or the like), utilizing or interacting with collectibles, displaying collectibles, organizing collectibles, storing collectibles, revealing collectibles, organizing collectibles, and/or the like.

In various examples, NFT collectible system 130 can be configured to provide a collectible system for NFT collectibles. For example, NFT collectible system 130 can offer a marketplace for NFT collectibles, in which a user can purchase NFT collectibles. NFT collectibles can be or comprise one or more digital files (e.g., image, video, audio, and/or text files, and/or the like) that are logged on a public ledger (e.g., a block chain). For example, one or more digital files can be minted or tokenized on a block in a block chain to create an NFT collectible. Accordingly, NFT collectible system 130 can be in communication with an NFT system or marketplace for buying, selling, and/or minting NFTs. In various examples, NFT collectible system 130 can comprise a system and/or marketplace for buying, selling, and minting NFT collectibles.

In various examples, an NFT collectible can comprise one or more digital files. The digital file(s) associated with an NFT collectible can be considered a digital collectible(s). The digital file/collectible associated with the NFT collectible can be logged on a private ledger. Thus, an NFT collectible can comprise components logged on a private and/or public ledger (e.g., the blockchain block associated with an NFT collectible can be logged on a public ledger, and the digital file/digital collectible associated with the blockchain block can be logged on a private ledger). The NFT collectible can also be logged on a private ledger as well as the associated public ledger (e.g., the associated blockchain).

An NFT collectible can be provided to NFT collectible system 130. The NFT can be minted in or by NFT collectible system 130 and/or received from an external NFT system or marketplace. In various examples, NFT collectible system 130 can comprise a crypto wallet to store NFTs (e.g., NFT collectibles). NFT collectible system 130 can generate an NFT collectible record associated with the respective NFT collectible, which can comprise images of and/or information about the NFT collectible. In various examples, the NFT collectible record can be associated with a single, unique NFT collectible. Therefore, the images and/or information in the NFT collectible record for a NFT collectible can reflect unique aspects of the NFT collectible. In response to a user purchasing a NFT collectible, the NFT collectible and associated NFT collectible record can be associated with the user profile in NFT collectible system 130 through which the purchase of the NFT collectible was completed. NFT collectible records and/or user profile information for NFT collectible system 130 can be stored in NCS database 134.

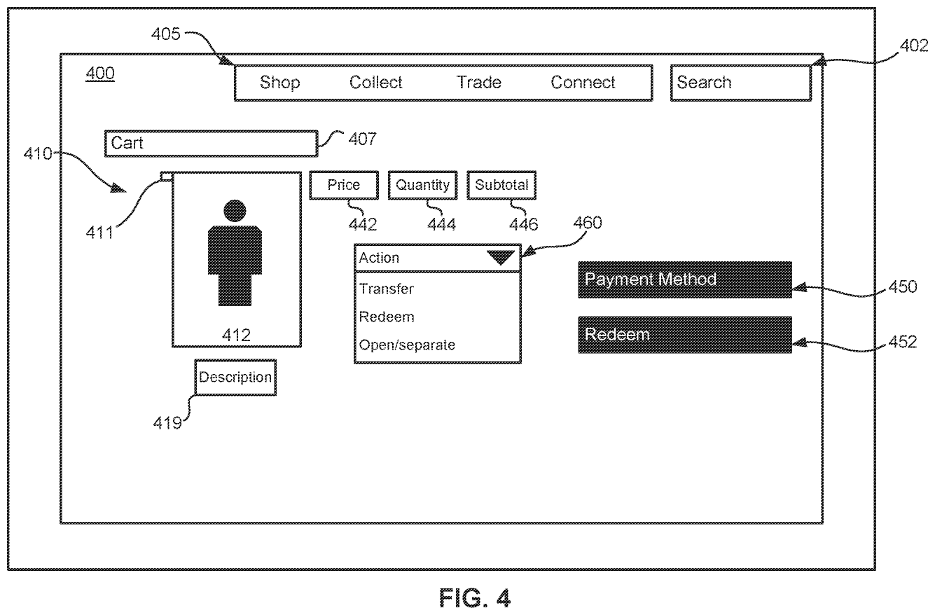

With additional reference to FIG. 4, an NCS GUI 400 (an example of NCS GUI 132 in FIG. 1) is depicted in accordance with various examples. An NCS GUI can allow a user to interact and communicate with NFT collectible system 130. NCS GUI 400, for example, can have an action selection pane 405 from which a user can select a desired action (similar to action selection pane 205 in ECS GUI 200).

A user can search for various items or aspects within NFT collectible system 130 (e.g., different collectibles or features of NFT collectible system 130) by utilizing a search bar 402. A user can select various collectibles (e.g., from their own collection or the collection or inventory of another party), upon or with which the user can act and/or transact. For example, the user of NCS GUI 400 may have searched for various NFT collectibles and selected NFT collectible 412. NFT collectible 412, or the NFT collectible record associated therewith, can be displayed in collectible display area 410. For example, NFT collectible system 130 can display one or more images and/or a description 419 (e.g., information) associated with NFT collectible 412. The images for an NFT collectible can be used to provide unique aspects of the specific NFT collectible, as discussed herein. In various examples, the display of a collectible in collectible display area 410 can comprise an identifier or marker 411 configured to indicate a characteristic of the collectible. For example, marker 411 can indicate the type of collectible, whether an action can be taken on the selected collectible (e.g., whether a collectible can be transferred to another user profile, physically shipped to a desired address, redeemed for another collectible (e.g., a redeemed collectible), bought or sold, and/or the like), a collectible category (e.g., a collectible relating to sports, games, fantasy worlds or universes, etc.), and/or the like). In various examples, the description 419 associated with a collectible can convey information to the viewer about the respective collectible, such as the associated title, brand, pictured subject, rarity, ownership information, collectible type, availability for certain actions, and/or the like.

NCS GUI 400 can be the display used to purchase an NFT collectible 412 (e.g., showing what is in a user's cart to purchase). The price 442, quantity 444, and subtotal 446 for a purchase can be displayed. In various examples, NCS GUI 400 can allow a user to select an action to take with regard to selected collectibles. For example, an action menu can allow the user to transfer, trade, redeem, buy, sell, and/or organize collectibles, and/or take any other suitable action. To pay for the selected NFT collectible, the user can select a payment button 450 to proceed to select a payment method, enter payment information, etc. In action menu 460, the user can select to transfer, redeem, or open or separate the associated items. For example, NFT collectible 412 can be transferred to a user profile in response to being purchased, transferred from one user profile to another (e.g., in a trade), transferred to another system, redeemed for a redeemed collectible, and/or multiple items in one NFT collectible can be opened, revealed, and/or separated.

In various examples, an NFT collectible having an NFT collectible record in NFT collectible system 130 can be transferred to electronic collectible system 110. A user may wish to consolidate collectibles from multiple locations into a single user profile and/or collection. Such consolidation can increase the convenience for displaying, viewing, transacting, and utilizing of collectibles of various types (e.g., digital/electronic, digital-only, physical, and/or NFT collectibles). Accordingly, NFT collectibles in NFT collectible system 130 can be transferred to electronic collectible system 110. Such a transfer can comprise transferring the NFT collectible record from NFT collectible system 130 to electronic collectible system 110 and/or electronic collectible system 110 generating a digital collectible record based on the NFT collectible record. The digital collectible record can comprise the same or similar information about the NFT collectible, which will be displayed on ECS GUI 112 in electronic collectible system 110 (e.g., a collectible in ECS GUI 200 could be NFT collectible 412 in NCS GUI 400). Thus, a user's NFT collectibles can join any other collectibles already present in the user profile in electronic collectible system 110.

In various examples, in response to transferring a NFT collectible from NFT collectible system 130 to electronic collectible system 110, the location of the NFT collectible can remain the same (e.g., in the same crypto wallet, on the same blockchain, etc.). In various examples, electronic collectible system 110 can comprise a crypto wallet for storing NFTs, cryptocurrencies, and/or other digital assets, and in response to transferring a NFT collectible from NFT collectible system 130 to electronic collectible system 110, the NFT collectible can be transferred to the crypto wallet in electronic collectible system 110 associated with the respective user profile.

Any action, function, and/or aspect of any of electronic collectible system 110, physical collectible system 120, and/or NFT collectible system 130, and/or their respective GUIs 200, 300, and/or 400 can be implemented on, in, and/or via any of the other systems, components, or GUIs in system 100.

In various examples, user device 140 can incorporate hardware and/or software components. For example, user device 140 can comprise a server appliance running a suitable server operating system (e.g., MICROSOFT INTERNET INFORMATION SERVICES or, “IIS”). User device 140 can be any device that allows a user to communicate with a network (e.g., a personal computer, personal digital assistant (e.g., IPHONE®, BLACKBERRY®), tablet, smartphone, cellular phone, and/or the like). User device 140 can be in electronic communication with electronic collectible system 110, physical collectible system 120, NFT collectible system 130, processor 190, consignment system 150, third-party vendor system 160, and/or input device 145. In various examples, user device 140 can comprise an input device 145 (i.e., a physical or digital button). User device 140 can allow the user of system 100 to interact with the other components of system 100. For example, user device 140 can comprise display screen 142, which can display a GUI (e.g., ECS GUI 112, PCS GUI 122, and/or NCS GUI 132) provided by system 100. Display screen 142 displaying a GUI can allow the user to select input device(s) 145 to send a signal to system 100 indicating a desired action by system 100. In various examples, any action performed by a user through system 100 can be communicated to system 100 and performed by a processor (e.g., processor 190).

User device 140 includes any device (e.g., personal computer, mobile device, etc.) which communicates via any network, for example such as those discussed herein. In various examples, user device 140 can comprise and/or run a browser, such as MICROSOFT® INTERNET EXPLORER®, MOZILLA FIREFOX®, GOOGLE® CHROME®, APPLE® Safari, or any other of the myriad software packages available for browsing the internet. For example, the browser can communicate with a server via network by using Internet browsing software installed in the browser. The browser can comprise Internet browsing software installed within a computing unit or a system to conduct online transactions and/or communications. These computing units or systems can take the form of a computer or set of computers, although other types of computing units or systems can be used, including laptops, notebooks, tablets, handheld computers, personal digital assistants, set-top boxes, workstations, computer-servers, mainframe computers, mini-computers, PC servers, pervasive computers, network sets of computers, personal computers, such as IPADS®, IMACS®, and MACBOOKS®, kiosks, terminals, point of sale (POS) devices and/or terminals, televisions, or any other device capable of receiving data over a network. In various examples, browser can be configured to display an electronic channel.

In various examples, a user device (e.g., as part of system 100) described herein can run a web application or native application to communicate with system 100. A native application can be installed on the user device via download, physical media, or an app store, for example. The native application can utilize the development code base provided for use with the operating system and capable of performing system calls to manipulate the stored and displayed data on the user device and communicates with system 100 and/or any components thereof. A web application can be web-browser compatible and written specifically to run on a web browser. The web application can thus be a browser-based application that operates in conjunction with system 100.

In various examples, consignment system 150 can incorporate hardware and/or software components. For example, consignment system 150 can comprise a server appliance running a suitable server operating system (e.g., MICROSOFT INTERNET INFORMATION SERVICES or, “IIS”) and having database software (e.g., ORACLE) installed thereon. Consignment system 150 can be in electronic communication with electronic collectible system 110, physical collectible system 120, NFT collectible system 130, processor 190, user device 140, third-party vendor system 160, and/or input device 145. In various examples, consignment system 150 can be configured to list collectibles for sale, for example, to reach a broader consumer base outside of system 100. Collectibles, and/or the collectible records associated therewith, can be transferred to electronic collectible system 110, as discussed herein. Through electronic collectible system 110, a user can list collectibles for sale, trade, or other transaction on consignment system 150. Consignment system 150 can receive the collectible record from electronic collectible system 110 and display the information comprised therein for consumers to view. Consignment system 150 can provide a payment processor and other systems necessary to complete transactions involving collectibles on electronic collectible system 110 or other components of system 100.

In various examples, consignment system 150 can be in electronic communication with at least one third party vendor 160. Consignment system 150 can provide the collectible records for listing by third party vendor(s) 160 to further offer such collectibles for sale or other transaction.

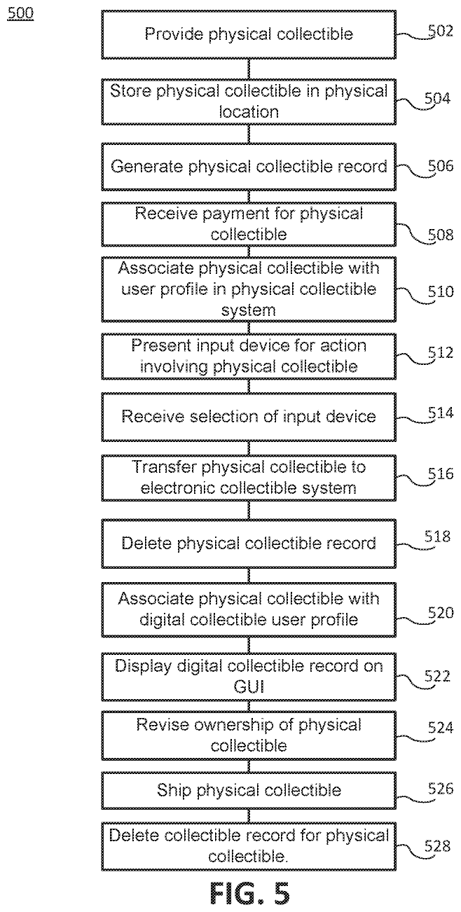

Referring now to FIGS. 5-7, the process flows and screenshots depicted are merely examples and are not intended to limit the scope of the disclosure. For example, the steps recited in any of the method or process descriptions can be executed in any order and are not limited to the order presented. Further, one or more steps described in one method can be implemented in another method discussed herein. It will be appreciated that the following description makes appropriate references not only to the steps depicted in FIGS. 5-7, but also to the various system components and user interface elements as described above with reference to FIGS. 1-4.

FIG. 5 depicts a method 500 for operating a system for collectibles including physical collectibles, in accordance with various examples. With combined reference to FIGS. 1-3 and 5, a physical collectible can be provided (step 502). A physical collectible can be provided in a physical collectible system 120. As discussed herein, a physical collectible can be a physical item, such as a trading card, poster, figurine, model, and/or any other item. The physical collectible can be a series or run of a collectible (e.g., a collectible of which multiple are made), or the physical collectible can be a unique item having its own unique characteristics (e.g., imperfections, damage, wear, or condition (for example, having a graded condition specific to the respective physical collectible)).

In various examples, the physical collectible can be stored in a physical location (step 504), such as a warehouse, on a shelf and/or the like. Storing the physical collectible can include generating (e.g., by physical collectible system 120) a physical collectible location record, which provides location information of the storage location of the respective physical collectible. In various examples, the physical collectible location record can comprise a stock-keeping unit(s) (“SKUs”) associated with the physical collectible. The SKUs can each be a unique identifier assigned to each physical collectible for purposes of tracking the physical collectible (e.g., with regard to ownership, physical location, inventory tracking, etc.). The SKUs can be recorded on a private ledger and/or a public ledger (such as a blockchain).

In various examples, a physical collectible record can be generated (step 506) for the physical collectible. A physical collectible record can be generated, for example, by physical collectible system 120 and/or electronic collectible system 110. A physical collectible record can comprise information about the associated physical collectible, including images or views of the physical collectible (e.g., from different angles, showing different aspects, unique features, damage, wear, and/or the like), a description of the physical collectible, ownership information for the current owner of the physical collectible, the marketplace(s) in which the physical collectible is available, the rarity and/or price of the physical collectible, the physical location (e.g., the physical collectible location record), the ability of the physical collectible to be shipped, and/or any other suitable information.

Physical collectible system 120 can display or present at least a portion of a physical collectible record (e.g., image(s) and/or a description of the physical collectible) on a PCS GUI 300. For example, different views 309 of physical collectible 312 can be displayed on PCS GUI 300 along with a description 319. Description 319 of physical collectible 312 can include any suitable information, including a collectible type, category, brand, team, subject, person/character, and/or the like. Physical collectible system 120 can present the physical collectible for sale on PCS GUI 300, for example, in response to a user selecting the “shop” action from action selection pane 305 and/or searching for the physical collectible in search bar 302.

In various examples, a user can purchase a physical collectible, for example, by selecting the desired physical collectible (e.g., physical collectible 312) and checking out through physical collectible system 120. The selected physical collectible can be placed in the user's cart (as shown on PCS GUI 300), and the user can select a payment button 350. Physical collectible system 120 can facilitate payment for physical collectible 312 (e.g., via a payment processor within or external to physical collectible system 120), and receive payment for the physical collectible (step 508). In response to receiving payment, physical collectible system 120 can associate the physical collectible with the respective user profile (step 510) (e.g., the user profile associated with the purchase of the physical collectible). Associating the physical collectible with the respective user profile can comprise associating the physical collectible record with the respective user profile (e.g., including updating the ownership information for the physical collectible to reflect the respective user profile), such that the images and/or information about the physical collectible is present in the user profile and the user's collection reflected in the user profile and/or on physical collectible system 120.

In various examples, physical collectible system 120 can present an input device or action button (e.g., an example of input device 145) to take an action involving the physical collectible (step 512). For example, to move the physical collectible between user profiles, between systems, or to a new physical location, the user can select an action from action menu 360. To transfer the physical collectible (or the physical collectible record) to another user profile (e.g., in a purchase or trade with another system user), or to another system such as electronic collectible system 110, the user can select the “transfer” action from action menu 360. The physical collectible 312 can also be shipped to the user, for example, in response to the user selecting the “ship” action from action menu 360.

In various examples, physical collectible system 120 can receive selection of the input device (step 514), which can cause physical collectible system 120 to perform an operation associated with the received selection. In response to receiving a selection of the input device for transferring the physical collectible, the physical collectible can be transferred from physical collectible system 120 to electronic collectible system 110 (step 516). In various examples, transferring the physical collectible from physical collectible system 120 to electronic collectible system 110 can comprise transferring the physical collectible record from physical collectible system 120 to electronic collectible system 110, and updating the physical collectible record to reflect such a transfer and the presence of the physical collectible in electronic collectible system 110 (e.g., stored in ECS database 114) (the updated physical collectible record from the transfer of the physical collectible to electronic collectible system 110 can be referred to as a digital collectible record). In various examples, transferring the physical collectible from physical collectible system 120 to electronic collectible system 110 can comprise electronic collectible system 110 generating a digital collectible record based on at least a portion of the information in the physical collectible record. There may be no physical movement (i.e., physical relocation) of the physical collectible in response to the transfer of the physical collectible from physical collectible system 120 to electronic collectible system 110. That is, the physical location of the physical collectible can remain the same or unchanged in response to transferring the physical collectible record to electronic collectible system 110. In various examples, the physical collectible can be moved to a new physical location in response to transferring the physical collectible record to electronic collectible system 110.

In response to transferring the physical collectible to electronic collectible system 110, the physical collectible record can be (automatically) deleted from physical collectible system 120 (step 518). Therefore, the transfer of a physical collectible to electronic collectible system 110 can serve to consolidate the collectibles belonging to a user of system 100 such that the user's collectibles are stored and available in one system and/or user profile/account, rather than multiple systems or accounts having duplicates therebetween. Also, the inventory and collectibles within system 100 can be kept on a private ledger, such that whether present on electronic collectible system 110, physical collectible system 120, or NFT collectible system 130, a collectible within system 100 is only reflected once, including on the private ledger. In various examples, a physical collectible can be present on physical collectible system 120 and electronic collectible system 110, and reflected once on the private ledger. In such examples, the digital collectible record can be associated with the physical collectible record.

Further, in response to transferring the physical collectible to electronic collectible system 110, the physical collectible (and/or the associated digital collectible record) can be associated with a digital collectible user profile (step 520) on electronic collectible system 110. Thus, the physical collectible can be incorporated into such user's collection stored and visible on electronic collectible system 110. The user can interact with, utilize (e.g., play games using), trade with, display, examine, organize, and/or take any other action with, the physical collectibles with any or all other collectibles (e.g., electronic/digital collectibles, digital-only collectibles, and/or NFT collectibles) in a user's collection in electronic collectible system 110.

In various examples, in response to transferring the physical collectible to electronic collectible system 110, the digital collectible record associated with the physical collectible can be displayed on electronic collectible system 110 (step 522) (e.g., on ECS GUI 200). For example, collectible 212 can be information displayed from the digital collectible record associated with physical collectible 312 that was transferred from physical collectible system 120. In various examples, the digital collectible record associated with a physical collectible can be considered the electronic or digital collectible counterpart to respective physical collectible.

In various examples, a user of system 100 can trade or sell the physical collectible on electronic collectible system 110 and/or physical collectible system 120, as appropriate. In response to such a transfer of ownership of the physical collectible, the respective system can update the ownership identifier and/or ownership information associated with the physical collectible (step 524), and/or associate the physical collectible (and/or the associated digital collectible record) with the new user profile. If the physical collectible is sold in electronic collectible system 110, electronic collectible system 110 can update the ownership information and the associated user profile. If the physical collectible is sold in physical collectible system 120, physical collectible system 120 can update the ownership information and the associated user profile. In response to a transfer of a physical collectible (or its digital collectible record) between user profiles, the physical location of the physical collectible may not change.

Similar to step 512 in which physical collectible system 120 presents an input device or action button, electronic collectible system 110 can present an input device or action button to take an action involving the physical collectible (and the digital collectible counterpart). For example, electronic collectible system 110 can receive a selection of transfer button 254, which can allow transfer of the physical collectible and/or its digital collectible record to another user profile and/or another system or component within system 100, as discussed herein. As another example, electronic collectible system 110 can receive a selection of ship button 252, which can indicate the user's desire to physically transfer or ship the physical collectible. In response, electronic collectible system 110 can command and/or facilitate the shipping of the physical collectible to a physical address. In response to the command to ship, the physical collectible can be shipped (step 526) to the desired physical address (e.g., shipping to the user).

In response to shipping the physical collectible to the desired physical address (e.g., shipping the physical collectible outside of system 100), the collectible record(s) associated with the physical collectible and any associated digital collectible can be deleted (step 528). For example, the digital collectible record can be deleted from electronic collectible system 110 and/or the physical collectible record can be deleted from physical collectible system 120.

The communication between electronic collectible system 110 and physical collectible system 120 allows physical collectibles present or represented, sold, exchanged, and/or utilized in a physical collectible marketplace (such as physical collectible system 120) to be located and included in the same electronic collection in an electronic system (such as electronic collectible system 110). Therefore, immediate transfer of physical collectibles can take place from physical collectible system 120 to electronic collectible system 110, and the physical collectibles can be intermingled and grouped with electronic, digital-only, and/or NFT collectibles. Thus, users of system 100 can take action including multiple types of collectibles (e.g., physical, electronic, digital-only, and/or NFT collectibles). For example, users can play games with multiple collectible types, make trades with other users involving multiple collectible types, exchange multiple collectible types for one or more redeemed collectibles that may be a different collectible type than one or more of the exchanged collectibles, and/or the like. System 100 allows physical collectibles to be immediately used for transacting.

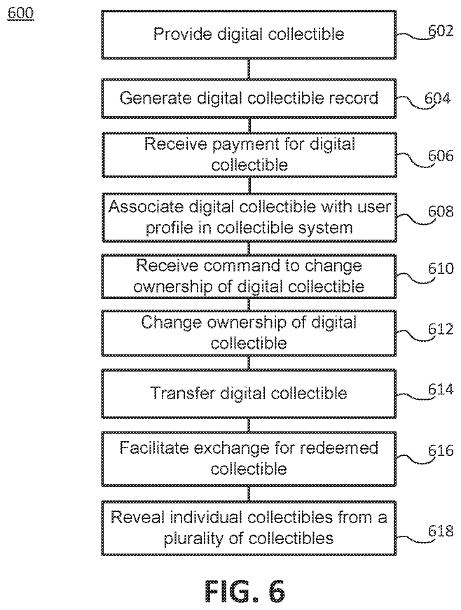

FIG. 6 depicts a method 600 for operating a system for collectibles including electronic and/or digital-only collectibles, in accordance with various examples. With regard to electronic and/or digital-only collectibles (not associated with NFTs), and with combined reference to FIGS. 1-3 and 6, a digital collectible can be provided (step 602), such as a digital and/or digital-only collectible (both referred to herein as digital collectibles). As discussed herein, a digital-only collectible can be a digital collectible with no physical or NFT collectible counterpart.

In various examples, a digital collectible record can be generated (step 604) for the digital collectible. For a digital-only collectible, a digital-only collectible record can be generated. A digital collectible record can be generated, for example, by electronic collectible system 110. A digital collectible record can comprise information about the associated digital collectible, including images of the digital collectible, a description of the digital collectible, ownership information for the current owner of the digital collectible, the marketplace(s) in which the digital collectible is available, the rarity and/or price of the digital collectible, the location (e.g., in which system(s) and/or marketplace(s)), the ability of the digital collectible to be shipped, and/or any other suitable information. In various examples, the digital collectible record can comprise a stock-keeping unit(s) (“SKUs”) associated with the digital collectible. The SKUs can each be a unique identifier assigned to each digital collectible for purposes of tracking the digital collectible (e.g., with regard to ownership, storage location, inventory tracking, etc.). The SKUs can be recorded on a private ledger and/or a public ledger (such as a blockchain).

Electronic collectible system 110 can display or present at least a portion of a digital collectible record (e.g., image(s) and/or a description of the digital collectible) on a ECS GUI 200. Description 219 of digital collectibles 214, 216 can include any suitable information, including a collectible type, category, brand, team, subject, person/character, and/or the like. Electronic collectible system 110 can present the digital collectible for sale on ECS GUI 200, for example, in response to a user selecting the “shop” action from action selection pane 205 and/or searching for the digital collectible in search bar 202.

In various examples, a user can purchase a digital collectible, for example, by selecting the desired digital collectible and checking out through electronic collectible system 110. The selected digital collectible can be placed in the user's cart, and the user can select a payment option. Electronic collectible system 110 can facilitate payment for the digital collectible (e.g., via a payment processor within or external to electronic collectible system 110), and receive payment for the digital collectible (step 606). In response to receiving payment, electronic collectible system 110 can associate the digital collectible with the respective user profile (step 608) (e.g., the user profile associated with the purchase of the digital collectible). Associating the digital collectible with the respective user profile can comprise associating the digital collectible record with the respective user profile, such that the images and/or information about the digital collectible is present in the user profile and the user's collection reflected in the user profile and/or on electronic collectible system 110 (and/or such that the respective digital collectible record comprises the user profile information as the ownership information).

In various examples, electronic collectible system 110 can present an input device or action button (e.g., an example of input device 145) to take an action involving the digital collectible. For example, electronic collectible system 110 can present an action menu 207 similar to action menu 360 in PCS GUI 300. To transfer the physical collectible between user profiles, for example, (e.g., to transfer ownership of a digital collectible) and/or between systems, the user can select transfer button 254.

In various examples, electronic collectible system 110 can receive a command to change the ownership of a digital collectible (step 610) (e.g., from a user's selection of the transfer button 254). In response, electronic collectible system 110 can change the ownership information or identifier for the digital collectible (step 612) and/or transfer the digital collectible (step 614) to another user profile in electronic collectible system 110 and/or another system. In response, the digital collectible record for the transferred digital collectible can be present and viewable in the other user profile, and/or the other user profile can be comprised in the ownership information for the transferred digital collectible.

In various examples, multiple collectibles can be exchanged for a redeemed collectible. For example, multiple (e.g., two, three, four, or more) of the same digital collectible can be exchanged for a redeemed collectible, which can be another digital collectible, a physical collectible (which can be transferred, shipped, utilized, etc. as discussed herein), and/or an NFT collectible. Such redemption offerings can allow users to reduce undesired duplicates in their collections. As another example, any combination of the same or different collectibles can be required to exchange for a redeemed collectible. Electronic collectible system 110 can facilitate an exchange of certain a collectible(s) to receive a redeemed collectible (step 616). In a redemption transaction, the exchanged collectible(s) can be submitted to electronic collectible system 110, and in exchange, electronic collectible system 110 can provide the redeemed collectible to the respective user profile. The redeemed collectible can already exist on the private ledger of system 100 before the redemption transaction, or in various examples, electronic collectible system 110 can generate the redeemed collectible in response to a user selecting redeem button 256, for example, and electronic collectible system 110 facilitating the redemption transaction. In response to receiving the exchanged collectible(s), electronic collectible system 110 can generate a digital collectible record for the redeemed collectible (a redeemed collectible record), and associate the redeemed collectible with the appropriate user profile. The redeemed collectible can comprise a digital collectible (and/or a physical collectible counterpart) with an associated digital collectible record, such as those discussed herein. The exchanged collectibles, after completion of the redemption transaction, can be made available for purchase or transfer to other users of electronic collectible system 110, or electronic collectible system 110 can (automatically) delete the digital collectibles and/or their associated digital collectible records.

In various examples, system 100 can offer packs of collectibles (e.g., trading cards) for purchase to users. The packs can be physical packs having physical cards therein and/or digital packs having digital cards therein. Physical packs, and each physical card therein, have a digital collectible counterpart. Physical packs can be purchased through physical collectible system 120 and/or electronic collectible system 110, and electronic packs can be purchased through electronic collectible system 110. The user can leave the packs unopened for any desired period of time. When desired, the user can open the digital pack of cards by selecting an input device instructing system 100 to open the pack and reveal the individual collectibles within the plurality of collectibles (step 618) from in the pack. Boxes of collectibles (comprising a plurality of packs), and cases of collectibles (comprising a plurality of boxes) are also available through system 100, which can also remain unopened for as long as desired.

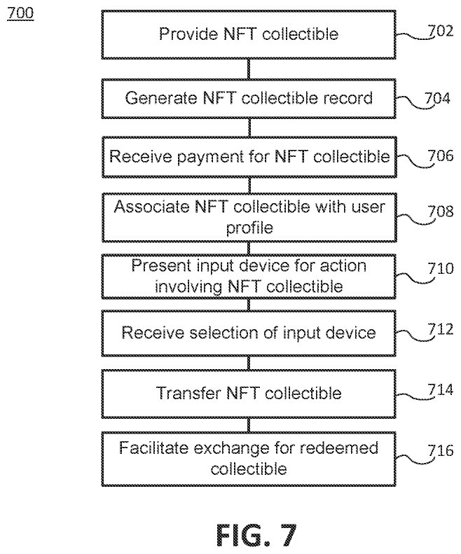

FIG. 7 depicts a method 700 for operating a system for collectibles including NFT collectibles, in accordance with various examples. With regard to NFT collectibles (which do not include “digital collectibles,” as termed in this disclosure), and with combined reference to FIGS. 1-4 and 7, an NFT collectible can be provided (step 702) to system 100 or a component thereof. An NFT collectible can comprise a digital file (e.g., a file comprising image, video, audio, and/or any other suitable content) stored on a blockchain. For example, an NFT can be minted or tokenized on an NFT marketplace external to NFT collectible system 130 and/or system 100, and the NFT can be provided or transferred to NFT collectible system 130 as an NFT collectible. In various examples, NFT collectible system 130, electronic collectible system 110, and/or system 100 can comprise an NFT minting system which can create NFT collectibles. An NFT collectible can comprise a digital collectible counterpart and/or a physical collectible counterpart.

In various examples, an NFT collectible record can be generated (step 704) for the NFT collectible. An NFT collectible record can be generated, for example, by NFT collectible system 130. An NFT collectible record can comprise information about the associated NFT collectible, including images of the NFT collectible, a description of the NFT collectible, ownership information for the current owner of the NFT collectible, the marketplace(s) in which the NFT collectible is available, the rarity and/or price of the NFT collectible, the location (e.g., in which system(s), blockchain(s), and/or marketplace(s) the NFT collectible is available or supported), and/or any other suitable information. In various examples, the NFT collectible record can comprise a stock-keeping unit(s) (“SKUs”) associated with the NFT collectible. The SKUs can each be a unique identifier assigned to each NFT collectible for purposes of tracking the NFT collectible (e.g., with regard to ownership, storage location, inventory tracking, etc.). The SKUs can be recorded on a private ledger and/or a public ledger (such as a blockchain).

NFT collectible system 130 can display or present at least a portion of an NFT collectible record (e.g., image(s) and/or a description of the digital collectible) on a NCS GUI 400. Description 419 of NFT collectible 412 can include any suitable information, including a collectible type (e.g., whether there is an electronic and/or physical collectible counterpart with the NFT collectible), category, brand, team, subject, person/character, rarity, and/or the like. NFT collectible system 130 can present the NFT collectible for sale on NCS GUI 400, for example, in response to a user selecting the “shop” action from action selection pane 405 and/or searching for the digital collectible in search bar 402.

In various examples, a user can purchase an NFT collectible, for example, by selecting the desired NFT collectible and checking out through NFT collectible system 130. The selected NFT collectible can be placed in the user's cart, and the user can select a payment option. NFT collectible system 130 can facilitate payment for the NFT collectible (e.g., via a payment processor within or external to NFT collectible system 130), and receive payment for the NFT collectible (step 706). In response to receiving payment, NFT collectible system 130 can associate the NFT collectible with the respective user profile (step 708) (e.g., the user profile associated with the purchase of the NFT collectible). Associating the NFT collectible with the respective user profile can comprise associating the NFT collectible record with the respective user profile, such that the images and/or information about the NFT collectible is present in the user profile and the user's collection reflected in the user profile and/or on NFT collectible system 130, and/or the other user profile can be comprised in the ownership information for the NFT collectible.

In various examples, NFT collectible system 130 can present an input device or action button (e.g., an example of input device 145) to take an action involving the NFT collectible (step 710). For example, to move the NFT collectible between user profiles and/or between systems, the user can select an action from action menu 460. To transfer the NFT collectible (or the NFT collectible record) to another user profile (e.g., in a purchase or trade with another system user), or to another system such as electronic collectible system 110, the user can select the “transfer” action from action menu 460. The NFT collectible 412 can also be exchanged in a redemption transaction, in response to the user selecting the “redeem” action from action menu 460, and/or be opened or separated if associated with multiple digital collectibles in response to the user selecting the “open/separate” action from action menu 460.

In various examples, NFT collectible system 130 can receive a selection of the input device (step 712), which can cause NFT collectible system 130 to perform an operation associated with the received selection. In response to receiving a selection of the input device for transferring the NFT collectible, the NFT collectible can be transferred (step 714) from NFT collectible system 130 to electronic collectible system 110. In various examples, transferring the NFT collectible from NFT collectible system 130 to electronic collectible system 110 can comprise transferring the NFT collectible record from NFT collectible system 130 to electronic collectible system 110, and updating the NFT collectible record to reflect such a transfer and the presence of the NFT collectible in electronic collectible system 110 (e.g., stored in ECS database 114) (the updated NFT collectible record from the transfer of the NFT collectible to electronic collectible system 110 can be referred to as a digital collectible record). In various examples, transferring the NFT collectible from NFT collectible system 130 to electronic collectible system 110 can comprise electronic collectible system 110 generating a digital collectible record for the transferred NFT collectible based on at least a portion of the information in the NFT collectible record.

As part of, and/or in response, to transferring the NFT collectible to electronic collectible system 110, the NFT collectible record can be (automatically) deleted from NFT collectible system 130. Therefore, the transfer of a NFT collectible to electronic collectible system 110 can serve to consolidate the collectibles belonging to a user of system 100 such that the user's collectibles are stored and available in one system, rather than multiple systems having duplicates therebetween. Also, the inventory and collectibles within system 100 can be kept on a private ledger, such that whether present on electronic collectible system 110, physical collectible system 120, or NFT collectible system 130, a collectible within system 100 is only reflected once, including on the private ledger. As discussed herein, the NFT collectible can also be recorded as a block on a blockchain for authentication purposes. In various examples, a NFT collectible can be present on NFT collectible system 130 and electronic collectible system 110, and reflected once on the private ledger. In such examples, the digital collectible record can be associated with the NFT collectible record.

Further, in response to transferring the NFT collectible to electronic collectible system 110, the NFT collectible (and/or the associated digital collectible record) can be associated with a digital collectible user profile on electronic collectible system 110. Thus, the NFT collectible can be incorporated into such user's collection stored and visible on electronic collectible system 110. The user can interact with, utilize (e.g., play games using), trade with, display, examine, organize, and/or take any other action with, the NFT collectibles with any or all other collectibles (e.g., electronic/digital collectibles, digital-only collectibles, and/or physical collectibles) in a user's collection in electronic collectible system 110.

In various examples, in response to transferring the NFT collectible to electronic collectible system 110, the digital collectible record for the NFT collectible can be displayed on electronic collectible system 110 (e.g., on ECS GUI 200). In various examples, the digital collectible record associated with a NFT collectible can be considered the electronic or digital collectible counterpart to respective NFT collectible.

In various examples, a user of system 100 can trade or sell the NFT collectible on electronic collectible system 110 and/or NFT collectible system 130, as appropriate. In response to such a transfer of ownership of the NFT collectible, the respective system can update the ownership identifier and/or ownership information associated with the physical collectible, and/or associate the NFT collectible (and/or the associated digital collectible record) with the new user profile. If the NFT collectible is sold in electronic collectible system 110, electronic collectible system 110 can update the ownership information and the associated user profile. If the NFT collectible is sold in NFT collectible system 130, NFT collectible system 130 can update the ownership information and the associated user profile. Similar to step 710 in which NFT collectible system 130 presents an input device or action button, electronic collectible system 110 can present an input device or action button to take an action involving the NFT collectible (and the digital collectible counterpart). For example, electronic collectible system 110 can receive a selection of a transfer button 254, which can allow transfer of the NFT collectible and/or its digital collectible record to another user profile and/or another system or component within system 100. In various examples, an NFT collectible can be transferred into system 100 (e.g., into electronic collectible system 110 and/or NFT collectible system 130) from an external system, and/or an NFT collectible can be transferred out of system 100 to an external system.

The communication between electronic collectible system 110 and NFT collectible system 130 allows NFT collectibles present or represented, sold, exchanged, and/or utilized in a NFT collectible marketplace (such as NFT collectible system 130) to be located and included in the same electronic collection in an electronic system (such as electronic collectible system 110). Therefore, immediate transfer of NFT collectibles can take place from NFT collectible system 130 to electronic collectible system 110, and the NFT collectibles can be intermingled and grouped with digital, digital-only, and/or physical collectibles. Thus, users of system 100 can take action including multiple types of collectibles (e.g., physical, electronic, digital-only, and/or NFT collectibles). For example, users can play games with multiple collectible types, make trades with other users involving multiple collectible types, exchange multiple collectible types for one or more redeemed collectibles that may be a different collectible type than one or more of the exchanged collectibles, and/or the like. System 100 allows NFT collectibles to be immediately used for transacting.

In various examples, as discussed herein in relation to digital collectibles, multiple collectibles can be exchanged for a redeemed collectible. For example, multiple (e.g., two, three, four, or more) of the same NFT collectible can be exchanged for a redeemed collectible, which can be another NFT collectible, a digital collectible, and/or a physical collectible (which can be transferred, shipped, utilized, etc. as discussed herein). Such redemption offerings can allow users to reduce undesired duplicates in their collections. As another example, any combination of the same or different collectibles can be required to exchange for a redeemed collectible. Electronic collectible system 110 can facilitate an exchange of certain a collectible(s) to receive a redeemed collectible (step 716). In a redemption transaction, the exchanged collectible(s) can be submitted to electronic collectible system 110, and electronic collectible system 110 can provide the redeemed collectible to the respective user profile. The redeemed collectible can already exist on the private ledger of system 100 before the redemption transaction, or in various examples, electronic collectible system 110 can generate the redemption transaction in response to a user selecting redeem button 452, for example, and electronic collectible system 110 facilitating the redemption transaction. In response to a redemption transaction, electronic collectible system 110 can generate a digital collectible record associated with the redeemed collectible. The redeemed collectible can comprise a digital collectible (and/or a physical or NFT collectible counterpart) with an associated digital collectible record, such as those discussed herein. The exchanged collectibles can be made available for purchase or transfer to other users of electronic collectible system 110, or electronic collectible system 110 can delete the digital collectibles and/or their associated digital collectible records.

A blockchain network may be used as the public ledger for creation and updating the blockchain associated with an NFT collectible. The blockchain network is configured to maintain a blockchain, in accordance with various embodiments. The blockchain network may be a peer-to-peer network that is private, federated, and/or public in nature (e.g., the ETHEREUM® system, the Bitcoin system, the HYPERLEDGER® Fabric system, etc.). Federated and private networks may offer improved control over the content of the blockchain and public networks may leverage the cumulative computing power of the network to improve security. The blockchain network may comprise various blockchain nodes (e.g., consensus participants) in electronic communication with each other, as discussed further herein. Each blockchain node may comprise a computing device configured to write blocks to the blockchain and validate blocks of the blockchain. The computing devices may take the form of a computer or processor, or a set of computers and/or processors or application specific integrated circuits (ASICs), although other types of computing units or systems may also be used. Exemplary computing devices include servers, pooled servers, laptops, notebooks, hand held computers, personal digital assistants, cellular phones, smart phones (e.g., an IPHONE® device, a BLACKBERRY® device, an ANDROID® device, etc.), tablets, wearables (e.g., smart watches and smart glasses), Internet of Things (IOT) devices, or any other device capable of receiving data over network. Each computing device may run applications to interact with the blockchain network, communicate with other devices, perform crypto operations, and otherwise operate within system 100. Computing devices may run a client application that can be a thin client (web), hybrid (i.e. web and native, such as iOS and ANDROID® systems), or native application to make API calls to interact with the blockchain, such as a web3 API compatible with blockchain databases maintained by the ETHEREUM® system.

The blockchain may be based on any blockchain technology such as, for example, ETHEREUM®, OPENCHAIN®, Chain Open Standard technology, HYPERLEDGE® Fabric, CORDA®, Connect™, Sawtooth™, etc. The blockchain may comprise a system of blocks containing data that are interconnected by reference to the previous block. Each block may link to the previous block and may include a timestamp. Data can be added to the blockchain by establishing consensus between the blockchain nodes based on proof of work, proof of stake, practical byzantine fault tolerance, delegated proof of stake, or other suitable consensus algorithms. When implemented in support of system 100, the blockchain may serve as an immutable log for transactions and related contracts and processes.

A blockchain address may be uniquely assigned to each blockchain node or participant to function as a unique identifier for each participant in a blockchain network. For example, each participant may register with a blockchain network, and/or an existing trust participant (e.g., identity provider), and may be assigned and provided a private key and public key pair. In various embodiments, a blockchain network may use a Hierarchical Deterministic (HD) solution to enable the creation of one or more child keys from one or more parents keys in a hierarchy. Each child key may be assigned to a participant in blockchain network 101. For example, a blockchain network may use BIP32, BIP39, and/or BIP44 to generate an HD tree of public addresses.

Systems, methods and computer program products are provided. In the detailed description herein, references to “various examples”, “one example”, “an example”, etc., indicate that the example described can include a particular feature, structure, or characteristic, but every example may not necessarily include the particular feature, structure, or characteristic. Moreover, such phrases are not necessarily referring to the same example. Further, when a particular feature, structure, or characteristic is described in connection with an example, it is submitted that it is within the knowledge of one skilled in the art to affect such feature, structure, or characteristic in connection with other examples whether or not explicitly described. After reading the description, it will be apparent to one skilled in the relevant art(s) how to implement the disclosure in alternative examples.

As used herein, “satisfy”, “meet”, “match”, “associated with” or similar phrases can include an identical match, a partial match, meeting certain criteria, matching a subset of data, a correlation, satisfying certain criteria, a correspondence, an association, an algorithmic relationship and/or the like.

Terms and phrases similar to “associate” and/or “associating” can include tagging, flagging, correlating, using a look-up table or any other method or system for indicating or creating a relationship between elements, such as, for example, (i) a collectible (ii) a collectible record, and/or (iii) a user profile. Moreover, the associating can occur at any point, in response to any suitable action, event, or period of time. The associating can occur at pre-determined intervals, periodic, randomly, once, more than once, or in response to a suitable request or action. Any of the information can be distributed and/or accessed via a software enabled link, wherein the link can be sent via an email, text, post, social network input and/or any other method known in the art.

The system and method can be described herein in terms of functional block components, screen shots, optional selections and various processing steps. It should be appreciated that such functional blocks can be realized by any number of hardware and/or software components configured to perform the specified functions. For example, the system can employ various integrated circuit components, e.g., memory elements, processing elements, logic elements, look-up tables, and the like, which can carry out a variety of functions under the control of one or more microprocessors or other control devices. Similarly, the software elements of the system can be implemented with any programming or scripting language such as C, C++, C #, JAVA®, JAVASCRIPT, VBScript, Macromedia Cold Fusion, COBOL, MICROSOFT® Active Server Pages, assembly, PERL, PHP, awk, Python, Visual Basic, SQL Stored Procedures, PL/SQL, any UNIX shell script, and extensible markup language (XML) with the various algorithms being implemented with any combination of data structures, objects, processes, routines or other programming elements. Further, it should be noted that the system can employ any number of conventional techniques for data transmission, signaling, data processing, network control, and the like. Still further, the system could be used to detect or prevent security issues with a client-side scripting language, such as JAVASCRIPT, VBScript or the like. For a basic introduction of cryptography and network security, see any of the following references: (1) “Applied Cryptography: Protocols, Algorithms, And Source Code In C,” by Bruce Schneier, published by John Wiley & Sons (second edition, 1995); (2) “JAVA® Cryptography” by Jonathan Knudson, published by O'Reilly & Associates (1998); (3) “Cryptography & Network Security: Principles & Practice” by William Stallings, published by Prentice Hall; all of which are hereby incorporated by reference.

As will be appreciated by one of ordinary skill in the art, the system may be embodied as a customization of an existing system, an add-on product, a processing apparatus executing upgraded software, a standalone system, a distributed system, a method, a data processing system, a device for data processing, and/or a computer program product. Accordingly, any portion of the system or a module can take the form of a processing apparatus executing code, an internet-based example, an entirely hardware example, or an example combining aspects of the internet, software and hardware. Furthermore, the system can take the form of a computer program product on a computer-readable storage medium having computer-readable program code means embodied in the storage medium. Any suitable computer-readable storage medium can be utilized, including hard disks, CD-ROM, optical storage devices, magnetic storage devices, and/or the like.

The system and method is described herein with reference to screen shots, block diagrams and flowchart illustrations of methods, apparatus (e.g., systems), and computer program products according to various examples. It will be understood that each functional block of the block diagrams and the flowchart illustrations, and combinations of functional blocks in the block diagrams and flowchart illustrations, respectively, can be implemented by computer program instructions.

These computer program instructions can be loaded onto a general-purpose computer, special purpose computer, or other programmable data processing apparatus to produce a machine, such that the instructions that execute on the computer or other programmable data processing apparatus create means for implementing the functions specified in the flowchart block or blocks. These computer program instructions can also be stored in a computer-readable memory that can direct a computer or other programmable data processing apparatus to function in a particular manner, such that the instructions stored in the computer-readable memory produce an article of manufacture including instruction means which implement the function specified in the flowchart block or blocks. The computer program instructions can also be loaded onto a computer or other programmable data processing apparatus to cause a series of operational steps to be performed on the computer or other programmable apparatus to produce a computer-implemented process such that the instructions which execute on the computer or other programmable apparatus provide steps for implementing the functions specified in the flowchart block or blocks.

Accordingly, functional blocks of the block diagrams and flowchart illustrations support combinations of means for performing the specified functions, combinations of steps for performing the specified functions, and program instruction means for performing the specified functions. It will also be understood that each functional block of the block diagrams and flowchart illustrations, and combinations of functional blocks in the block diagrams and flowchart illustrations, can be implemented by either special purpose hardware-based computer systems which perform the specified functions or steps, or suitable combinations of special purpose hardware and computer instructions. Further, illustrations of the process flows and the descriptions thereof may make reference to user WINDOWS®, webpages, websites, web forms, prompts, etc. Practitioners will appreciate that the illustrated steps described herein can comprise in any number of configurations including the use of WINDOWS®, webpages, web forms, popup WINDOWS®, prompts and the like. It should be further appreciated that the multiple steps as illustrated and described can be combined into single webpages and/or WINDOWS® but have been expanded for the sake of simplicity. In other cases, steps illustrated and described as single process steps can be separated into multiple webpages and/or WINDOWS® but have been combined for simplicity.

As used herein, “transmit,” “transfer,” and/or the like can include sending electronic data from one system component to another over a network connection. Additionally, as used herein, “data” can include encompassing information such as commands, queries, files, data for storage, and the like in digital or any other form.

As used herein, the term “network” includes any cloud, cloud computing system or electronic communications system or method which incorporates hardware and/or software components. Communication among the parties can be accomplished through any suitable communication channels, such as, for example, a telephone network, an extranet, an intranet, Internet, point of interaction device (point of sale device, personal digital assistant (e.g., IPHONE®, BLACKBERRY®), cellular phone, kiosk, etc.), online communications, satellite communications, off-line communications, wireless communications, transponder communications, local area network (LAN), wide area network (WAN), virtual private network (VPN), networked or linked devices, keyboard, mouse and/or any suitable communication or data input modality. Moreover, although the system is frequently described herein as being implemented with TCP/IP communications protocols, the system can also be implemented using IPX, APPLE®talk, IP-6, NetBIOS®, OSI, any tunneling protocol (e.g. IPsec, SSH), or any number of existing or future protocols. If the network is in the nature of a public network, such as the Internet, it may be advantageous to presume the network to be insecure and open to eavesdroppers. Specific information related to the protocols, standards, and application software utilized in connection with the Internet is generally known to those skilled in the art and, as such, need not be detailed herein. See, for example, DILIP NAIK, INTERNET STANDARDS AND PROTOCOLS (1998); JAVA® 2 COMPLETE, various authors, (Sybex 1999); DEBORAH RAY AND ERIC RAY, MASTERING HTML 4.0 (1997); and LOSHIN, TCP/IP CLEARLY EXPLAINED (1997) and DAVID GOURLEY AND BRIAN TOTTY, HTTP, THE DEFINITIVE GUIDE (2002), the contents of which are hereby incorporated by reference.

The term “non-transitory” is to be understood to remove only propagating transitory signals per se from the claim scope and does not relinquish rights to all standard computer-readable media that are not only propagating transitory signals per se. Stated another way, the meaning of the term “non-transitory computer-readable medium” and “non-transitory computer-readable storage medium” should be construed to exclude only those types of transitory computer-readable media which were found in In Re Nuijten to fall outside the scope of patentable subject matter under 35 U.S.C. § 101.

Benefits, other advantages, and solutions to problems have been described herein with regard to specific examples. However, the benefits, advantages, solutions to problems, and any elements that may cause any benefit, advantage, or solution to occur or become more pronounced are not to be construed as critical, required, or essential features or elements of the disclosure. The scope of the disclosure is accordingly to be limited by nothing other than the appended claims, in which reference to an element in the singular is not intended to mean “one and only one” unless explicitly so stated, but rather “one or more.” Moreover, where a phrase similar to ‘at least one of A, B, and C’ or ‘at least one of A, B, or C’ is used in the claims or specification, it is intended that the phrase be interpreted to mean that A alone can be present in an example, B alone can be present in an example, C alone can be present in an example, or that any combination of the elements A, B and C can be present in a single example; for example, A and B, A and C, B and C, or A and B and C. Although the disclosure includes a method, it is contemplated that it can be embodied as computer program instructions on a tangible computer-readable carrier, such as a magnetic or optical memory or a magnetic or optical disk. All structural, chemical, and functional equivalents to the elements of the above-described various examples that are known to those of ordinary skill in the art are expressly incorporated herein by reference and are intended to be encompassed by the present claims. Moreover, it is not necessary for a device or method to address each and every problem sought to be solved by the present disclosure, for it to be encompassed by the present claims. Furthermore, no element, component, or method step in the present disclosure is intended to be dedicated to the public regardless of whether the element, component, or method step is explicitly recited in the claims.

No claim element is intended to invoke 35 U.S.C. 112(f) unless the element is expressly recited using the phrase “means for.” As used herein, the terms “comprises”, “comprising”, or any other variation thereof, are intended to cover a non-exclusive inclusion, such that a process, method, article, or apparatus that comprises a list of elements does not include only those elements but can include other elements not expressly listed or inherent to such process, method, article, or apparatus.

What is claimed is:

1. A method, comprising:
providing a physical collectible;
storing the physical collectible in a physical location;
generating, by a processor, a physical collectible location record associated with the physical location and a physical collectible system;
generating, by the processor, a physical collectible record associated with the physical collectible and the physical collectible system;
associating, by a processor, the physical collectible with a physical collectible user profile in the physical collectible system;
presenting, by the processor and on a physical collectible system graphical user interface (GUI), an input device for at least one of an electronic transfer of the physical collectible or a physical transfer of the physical collectible;
receiving, by the processor, a selection of the input device for an electronic transfer of the physical collectible; and
electronically transferring, by the processor, the physical collectible to an electronic collectible system in electronic communication with the physical collectible system by at least one of transferring, by the processor, the physical collectible record to the electronic collectible system or generating, by the processor, a digital collectible record based on the physical collectible record, wherein the physical location of the physical collectible remains the same in response to the electronically transferring the physical collectible to the electronic collectible system.

2. The method of claim 1, wherein the input device is for the physical transfer of the physical collectible, and wherein the electronically transferring the physical collectible to the electronic collectible system occurs automatically in response to the associating the physical collectible to the physical collectible user profile in the physical collectible system.

3. The method of claim 2, further comprising receiving, by the processor, a payment for the physical collectible associated with the physical collectible user profile, and wherein the associating the physical collectible with the physical collectible user profile is in response to the receiving the payment.

4. The method of claim 1, wherein the physical collectible record comprises a physical collectible image and a physical collectible description of the physical collectible, wherein the method further comprises displaying, by the processor, the physical collectible image and the physical collectible description on an electronic collectible system GUI in response to the transferring the physical collectible to the electronic collectible system.

5. The method of claim 4, further comprising automatically deleting, by the processor, the physical collectible record from the physical collectible system in response to the electronically transferring the physical collectible to the electronic collectible system.

6. The method of claim 4, wherein the digital collectible record comprises ownership information associated with an ownership of the physical collectible, wherein the method further comprises:
associating, by the processor, the physical collectible with a digital collectible user profile in the electronic collectible system in response to the electronically transferring the physical collectible to the electronic collectible system;
receiving, by the processor, a command to change the ownership of the physical collectible to a second digital collectible user profile in the electronic collectible system; and
revising, by the processor, the ownership information for the physical collectible to be associated with the second digital collectible user profile in response to receiving the command to change the ownership,
wherein the physical location of the physical collectible remains the same in response to the revising the ownership of the physical collectible.

7. The method of claim 4, further comprising:
presenting, by the processor and on the electronic collectible system GUI, a second input device indicating available actions for a collectible, including physical transfer of the physical collectible;
receiving, by the processor, a selection of the second input device for the physical transfer of the physical collectible;
commanding, by the processor, shipping the physical collectible to a second physical location; and
shipping the physical collectible to the second physical location.

8. The method of claim 7, further comprising automatically deleting, by the processor, the digital collectible record for the physical item in response to the shipping the physical collectible.

9. The method of claim 1, further comprising:
providing, by the processor, a digital-only digital collectible not associated with any physical collectible in the electronic collectible system;
generating, by the processor, a digital-only collectible record in the electronic collectible system associated with the digital-only digital collectible, wherein the digital-only collectible record is logged in a private ledger associated with the electronic collectible system; and
associating, by a processor, the digital-only digital collectible with a digital collectible user profile in the electronic collectible system.

10. The method of claim 9, wherein the digital-only collectible record comprises ownership information associated with an ownership of the digital-only digital collectible, wherein the method further comprises:
receiving, by the processor, a command to change the ownership of the digital-only digital collectible to a second digital collectible user profile in the electronic collectible system; and
revising, by the processor, the ownership information of the digital-only digital collectible to be associated with the second digital collectible user profile in response to receiving the command to change the ownership.

11. The method of claim 9, further comprising:
presenting, by the processor, a redeem input device on the electronic collectible system GUI through which a user is able to redeem a redeemed collectible in exchange for at least one of the digital-only digital collectible or the physical collectible;
receiving, by the processor, a selection of the redeem input device;
automatically generating, by the processor, a redeemed collectible record associated with the redeemed collectible;
associating, by the processor, the redeemed collectible record with the digital collectible user profile; and
automatically deleting, by the processor, at least one of the digital-only collectible record or the digital collectible record associated with the physical collectible from the digital collectible user profile.

12. The method of claim 1, further comprising:
providing, by the processor, an NFT collectible in an NFT collectible system in electronic communication with the electronic collectible system, wherein the NFT collectible is stored on a blockchain;
generating, by the processor, an NFT collectible record in the NFT collectible system associated with the NFT collectible, wherein the NFT collectible record is logged in a private ledger associated with the NFT collectible system; and
associating, by a processor, the NFT collectible with an NFT collectible user profile in the NFT collectible system.

13. The method of claim 12, further comprising:
presenting, by the processor and on an NFT collectible system GUI, an input device for an electronic transfer of the NFT collectible;
receiving, by the processor, a selection of the input device; and
transferring, by the processor, the NFT collectible record to the electronic collectible system.

14. A system comprising:
a processor; and
a tangible, non-transitory memory configured to communicate with the processor, the tangible, non-transitory memory having instructions stored thereon that, in response to execution by the processor, cause the processor to perform operations comprising:
generating, by the processor, a physical collectible location record associated with a physical location of a physical collectible and a physical collectible system;
generating, by the processor, a physical collectible record associated with the physical collectible and the physical collectible system;
associating, by a processor, the physical collectible with a physical collectible user profile in the physical collectible system;
presenting, by the processor and on a physical collectible system graphical user interface (GUI), an input device for at least one of an electronic transfer of the physical collectible or a physical transfer of the physical collectible;
receiving, by the processor, a selection of the input device for an electronic transfer of the physical collectible; and
electronically transferring, by the processor, the physical collectible to an electronic collectible system in electronic communication with the physical collectible system by at least one of transferring, by the processor, the physical collectible record to the electronic collectible system or generating, by the processor, a digital collectible record based on the physical collectible record, wherein the physical location of the physical collectible remains the same in response to the electronically transferring the physical collectible to the electronic collectible system.

15. The system of claim 14, wherein the operations further comprise automatically deleting, by the processor, the physical collectible record from the physical collectible system in response to the electronically transferring the physical collectible to the electronic collectible system.

16. The system of claim 14, wherein the operations further comprise:
presenting, by the processor and on an electronic collectible system GUI, a second input device indicating available actions for a collectible, including physical transfer of the physical collectible;
receiving, by the processor, a selection of the second input device for the physical transfer of the physical collectible;
commanding, by the processor, shipping the physical collectible to a second physical location; and
shipping the physical collectible to the second physical location.

17. The system of claim 16, wherein the operations further comprise automatically deleting, by the processor, the digital collectible record for the physical item in response to the shipping the physical collectible.

18. The system of claim 14, wherein the operations further comprise:
providing, by the processor, an NFT collectible in an NFT collectible system in electronic communication with the electronic collectible system, wherein the NFT collectible is stored on a blockchain;
generating, by the processor, an NFT collectible record in the NFT collectible system associated with the NFT collectible, wherein the NFT collectible record is logged in a private ledger associated with the NFT collectible system; and
associating, by a processor, the NFT collectible with an NFT collectible user profile in the NFT collectible system.

19. The system of claim 18, wherein the operations further comprise:
presenting, by the processor and on an NFT collectible system GUI, an input device for an electronic transfer of the NFT collectible;
receiving, by the processor, a selection of the input device; and
transferring, by the processor, the NFT collectible record to the electronic collectible system.

20. An article of manufacture including a non-transitory, tangible computer readable storage medium having instructions stored thereon that, in response to execution by a processor, cause the processor to perform operations comprising:
generating, by the processor, a physical collectible location record associated with a physical location of a physical collectible and a physical collectible system;
generating, by the processor, a physical collectible record associated with the physical collectible and the physical collectible system;
associating, by a processor, the physical collectible with a physical collectible user profile in the physical collectible system;
presenting, by the processor and on a physical collectible system graphical user interface (GUI), an input device for at least one of an electronic transfer of the physical collectible or a physical transfer of the physical collectible;
receiving, by the processor, a selection of the input device for an electronic transfer of the physical collectible; and
electronically transferring, by the processor, the physical collectible to an electronic collectible system in electronic communication with the physical collectible system by at least one of transferring, by the processor, the physical collectible record to the electronic collectible system or generating, by the processor, a digital collectible record based on the physical collectible record, wherein the physical location of the physical collectible remains the same in response to the electronically transferring the physical collectible to the electronic collectible system.
